(19) United States
(12) Patent Application Publication
(10) Pub. No.: US 2020/0081022 A1
(43) Pub. Date: Mar. 12, 2020

(54) REAGENT FLUID CARTRIDGE STORAGE DEVICES

(71) Applicant: HEWLETT-PACKARD DEVELOPMENT COMPANY, L.P., Spring, TX (US)

(72) Inventors: Jeffrey A. Nielsen, Corvallis, OR (US); Heather B. Louderback, Corvallis, OR (US); Suzanne Mirashrafi, Corvallis, OR (US); Dennis R. Esterberg, Corvallis, OR (US)

(73) Assignee: HEWLETT-PACKARD DEVELOPMENT COMPANY, L.P., Spring, TX (US)

(21) Appl. No.: 16/603,175

(22) PCT Filed: Jul. 18, 2017
(86) PCT No.: PCT/US2017/042593

§ 371 Date: Oct. 4, 2019

(51) Int. Cl. G01N 35/10; G01N 35/02; B01L 3/00

(52) U.S. Cl. CPC G01N 35/1002; B01L 3/527; G01N 35/025

(57) ABSTRACT

A reagent dispensing system may, in an example, include a processing device, a memory device coupled to the processing device, and a plurality of swappable reagent dispensing cartridges wherein a first set of the swappable reagent dispensing cartridges are maintained within a storage device off-line from a second set of swappable reagent dispensing cartridges maintained in-line.

### BACKGROUND

The life sciences research and associated diagnostic industries use a number of reagents and patient samples to perform testing and diagnostics of illnesses. These testing and diagnostic processes may be completed using human interaction with hand tools.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a reagent dispensing system according to an example of the principles described herein.

FIG. 2 is a block diagram of a reagent dispensing system according to an example of the principles described herein.

FIG. 3 is a block diagram of a swappable reagent storage device according to an example of the principles described herein.

FIG. 4 is a block diagram of a computer program product according to an example of the principles described herein.

FIG. 5 is a block diagram of a method for operating a reagent dispensing system according to an example of the principles described herein.

FIG. 6 is a block diagram of a computer program product according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Human interaction during life science research and diagnostic processes may lead to mistakes in those processes. Such mistakes may decrease the likelihood of scientific breakthroughs and increase the likelihood of misdiagnosis of patients illnesses. Further, with human interaction, these processes may prove tedious thereby increasing the costs associated with these processes as well as increase the time spent completing the processes. Automation of these processes, however, limits mistakes, time, and costs.

Instruments and tools used in life science research and diagnostic processes have been developed to increase efficiency, decrease costs, and decrease time spent conducting this research or completing diagnosis. However, even with these developments, increased numbers of reagents used to interact with a sample increase the complexity and time of completing those tasks.

The present specification describes a reagent dispensing system that includes a processing device, a memory device coupled to the processing device, and a plurality of swappable reagent dispensing cartridges wherein a first set of the swappable reagent dispensing cartridges are maintained within a storage device off-line from a second set of swappable reagent dispensing cartridges maintained in-line.

Additionally, the present specification describes a swappable reagent cartridge storage device, that includes a plurality of swappable reagent dispensing cartridges maintained in the storage device, each of the swappable reagent dispensing cartridges being grouped within a removable deck tray and a swapping device to exchange at least one of the swappable reagent dispensing cartridges within the storage device.

Further, the present specification describes a computer program product for dispensing a reagent that includes a computer readable storage medium comprising computer usable program code embodied therewith, the computer usable program code to, when executed by a processor swap at least one swappable reagent dispensing cartridge between an in-line position within a reagent dispensing system to an off-line storage device and service a number of swappable reagent dispensing cartridges within the storage device.

Even further, the present specification describes a computer program product for dispensing a reagent, that includes a computer readable storage medium comprising computer usable program code embodied therewith, the computer usable program code to, when executed by a processor service a number of swappable reagent dispensing cartridges within a storage device, wherein each of the number of swappable reagent dispensing cartridges are serviced based on a type of reagent maintained therein.

As used in the present specification and in the appended claims, the term “in-line” is meant to be understood as a position of a reagent dispensing cartridge in a reagent dispensing system where the reagent dispensing cartridge can eject an amount of reagent fluid onto a substrate. The in-line position may be directly above the substrate to have reagent fluid ejected onto.

Additionally, as used in the present specification and in the appended claims, the term “off-line” is meant to be understood as a position of a reagent dispensing cartridge in a reagent dispensing system where the reagent dispensing cartridge is stored away for future use or at least not “in-line.” In an example, the off-line position may be located in a module or cartridge storage unit within the reagent dispensing system.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

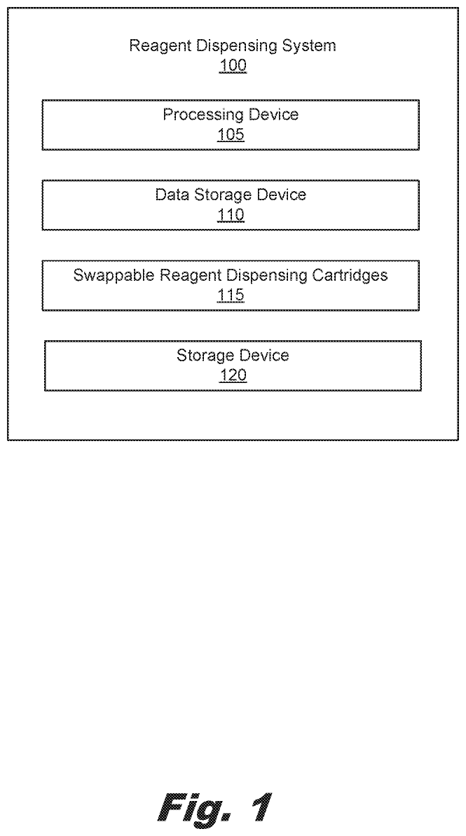

Turning now to the figures, FIG. 1 is a block diagram of a reagent dispensing system (100) according to an example of the principles described herein. The reagent dispensing system (100) may include a processing device (105), a data storage device (110) coupled to the processing device, and a plurality of swappable reagent dispensing cartridges (115). In an example, a first set of swappable reagent dispensing cartridges (115) may be maintained off-line in a storage device (120). As will be described in the present disclosure, the storage device (120) maintains the plurality of swappable reagent dispensing cartridges (115) off-line when a first set swappable reagent dispensing cartridges (115) are not to be placed on-line. In this scenario, the swappable reagent dispensing cartridges (115) not placed on-line and instead in the storage device (120) are not being used during a testing or diagnosis process executed by the reagent dispensing system (100). A number of reasons exist for the first set of swappable reagent dispensing cartridges (115) not being placed on-line and instead being placed in the storage device (120). In an example, the first set of swappable reagent dispensing cartridges (115) are maintained in the storage device (120) because the individual swappable reagent dispensing cartridges (115) or a group of the swappable reagent dispensing cartridges (115) have been deemed to not be of use for a particular test or diagnosis. In an example, the first set of swappable reagent dispensing cartridges (115) are maintained in the storage device (120) because the individual swappable reagent dispensing cartridges (115) or a group of the swappable reagent dispensing cartridges (115) do not include a sufficient amount of reagent fluids within at least one of the swappable reagent dispensing cartridges (115) to conduct a particular test or diagnosis.

To achieve its desired functionality, the reagent dispensing system (100) may further include additional various hardware components. In addition to the processing device (105) and the data storage device (110), these additional components may include a number of peripheral device adapters and a number of network adapters. These hardware components may be interconnected through the use of a number of busses and/or network connections. In one example, the processing device (105), data storage device (110), peripheral device adapters, and a network adapter may be communicatively coupled via a bus.

The processing device (105) may include the hardware architecture to retrieve executable code from the data storage device (110) and execute the executable code. The executable code may, when executed by the processing device (105), cause the processing device (105) to implement at least the functionality of swapping at least one swappable reagent dispensing cartridge (115) between an in-line position within the reagent dispensing system (100) to an off-line storage device (120), swapping at least one swappable reagent dispensing cartridge (115) between an off-line position within the reagent dispensing system (100) to an in-line storage device (120), and service a number of the swappable reagent dispensing cartridges (115) within the storage device (120) according to the methods of the present specification described herein. In the course of executing code, the processing device (105) may receive input from and provide output to a number of the remaining hardware units.

The data storage device (110) may store data such as executable program code that is executed by the processing device (105). As will be discussed, the data storage device (110) may specifically store computer code representing a number of applications that the processing device (105) executes to implement at least the functionality described herein.

The data storage device (110) may include various types of memory modules, including volatile and nonvolatile memory. For example, the data storage device (110) of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device (120) as may suit a particular application of the principles described herein. In certain examples, different types of memory in the data storage device (120) may be used for different data storage needs. For example, in certain examples the processing device (105) may boot from Read Only Memory (ROM), maintain nonvolatile storage in the Hard Disk Drive (HDD) memory, and execute program code stored in Random Access Memory (RAM). Generally, the data storage device (110) may comprise a computer readable medium, a computer readable storage medium, or a non-transitory computer readable medium, among others.

The hardware adapters in the reagent dispensing system (100) enable the processing device (105) to interface with various other hardware elements, external and internal to the reagent dispensing system (100). For example, the peripheral device adapters may provide an interface to input/output devices, such as, for example, a display device, a mouse, or a keyboard. The peripheral device adapters may also provide access to other external devices such as an external storage device, a number of network devices such as, for example, servers, switches, and routers, client devices, other types of computing devices, and combinations thereof.

A display device may be provided with the reagent dispensing system (100) to allow a user of the reagent dispensing system (100) to interact with and implement the functionality of the reagent dispensing system (100) described herein. In an example, the display device may be provided that may present, to a user, certain graphical user interfaces that present to a user test process selections or diagnostic selections. The peripheral device adapters may also create an interface between the processing device (105) and the display device, a printer, or other media output devices. The network adapter may provide an interface to other computing devices within, for example, a network, thereby enabling the transmission of data between the reagent dispensing system (100) and other devices located within the network.

The reagent dispensing system (100) via may display the number of graphical user interfaces (GUIs) on the display device associated with the executable program code representing the number of applications stored on the data storage device (110). Via making a number of interactive gestures on the GUIs of the display device, a user may indicate which test is to be completed using which reagent. With this input, the reagent dispensing system (100) may select, from the storage device (120), an appropriate number or group of swappable reagent dispensing cartridges (115). The selection of the test specific swappable reagent dispensing cartridges (115) may further include using an automated storage and retrieval system (ASRS) to swap a first set or first number of in-line swappable reagent dispensing cartridges (115) for some of the swappable reagent dispensing cartridges (115) maintained in the storage device (120). Examples of display devices may include a computer screen, a laptop screen, a mobile device screen, a personal digital assistant (PDA) screen, and a tablet screen, among other display devices.

The swappable reagent dispensing cartridges (115) may each include an identification. In an example, the identification may be in the form of a tag, a barcode, a near-field communication tag, among other types of identification. The reagent dispensing system (100) may include an identity tag reader that can read or otherwise detect the identity tag and obtain information regarding the swappable reagent dispensing cartridges (115). Information association with each of the swappable reagent dispensing cartridges (115) may include the manufacturer of the swappable reagent dispensing cartridges (115), the reagents maintained in the swappable reagent dispensing cartridges (115), the expiration date of the reagents in the swappable reagent dispensing cartridges (115), the type of test conducted using the swappable reagent dispensing cartridges (115), other reagent containing swappable reagent dispensing cartridges (115) any specific swappable reagent dispensing cartridges (115) may be grouped with, among other information.

In an example, a plurality of swappable reagent dispensing cartridges (115) may be physically grouped together using a cartridge module that physically holds each of the swappable reagent dispensing cartridges (115) together for swapping the swappable reagent dispensing cartridges (115) between an in-line position and an off-line position within the reagent dispensing system (100). Each of the modules may be maintained in the storage device (120) as described herein.

The storage device (120) may be any type of storage device that may maintain any number of swappable reagent dispensing cartridges (115) or groups of swappable reagent dispensing cartridges (115) therein. In an example, those swappable reagent dispensing cartridges (115) not in used by the reagent dispensing system (100) are maintained in the storage device (120). In order to hold the swappable reagent dispensing cartridges (115) in the storage device (120) for any amount of time, the storage device (120) may further include devices used to maintain the health of each of the swappable reagent dispensing cartridges (115). In particular, each of the swappable reagent dispensing cartridges (115) may include, in addition to a reagent held within the swappable reagent dispensing cartridges (115), an ejection device used to eject the reagent out from the swappable reagent dispensing cartridges (115) and onto a substrate. To maintain the reagents and, at least, the ejection device, storage device (120) may include additional devices. In an example, the storage device (120) may include a capping system that caps each of the ejection devices of each of the swappable reagent dispensing cartridges (115). The capping device may prevent drying of the ejection device as well as prevent contaminants from contacting the ejection device. The storage device (120) may further include a wiping station that may wipe each of the ejection devices of each of the swappable reagent dispensing cartridges (115). The storage device (120) may further include a spittoon where each of the ejection devices may eject a small amount of reagent into in order to maintain the health of the ejection device as well as to detect any defects in the ejection device itself.

The storage device (120) may further include environmental controls that control the environment in which each of the swappable reagent dispensing cartridges (115) or groups of swappable reagent dispensing cartridges (115) are maintained. In some cases, the reagents maintained in the storage device (120) may expire relatively quicker if they are not kept at a certain temperature. In this example, the storage device (120) may include a refrigeration device or a heating device used to maintain the reagents within the individual swappable reagent dispensing cartridges (115) or groups of swappable reagent dispensing cartridges (115). This allows the reagents to be maintained relatively longer within the storage device (120) when not in used an in an in-line position within the reagent dispensing system (100).

The storage device (120) may further include a humidifier and/or dehumidifier in order to maintain the humidity within the environment of the storage device (120). The humidifier and/or dehumidifier may also be used to help maintain the health of the ejection devices of the each of the swappable reagent dispensing cartridges (115).

The storage device (120) may further include barriers used to prevent electromagnetic waves from interacting with the reagents within the swappable reagent dispensing cartridges (115). This may include walls within the storage device (120) that prevent radiation from contacting the swappable reagent dispensing cartridges (115) and may include any type of barrier in order to achieve that function. In some examples, some of the reagents may be susceptible to UVA and/or UVB light. In these examples, the barrier may be a covering that prevents, for example sunlight, from entering the storage device (120). In some examples, the reagents maintained in the storage device (120) may be susceptible or otherwise changed when subjected to a type of nuclear radiation. Indeed, in some examples, some the of the reagents may be radioactive themselves. In order to prevent the destruction of some of the reagents, the storage device (120) may have a barrier that consists of materials used to block alpha, beta, and or gamma particles from entering the storage device (120). Other environmental control devices may be implemented within the storage device (120) and the present specification contemplates their use.

The storage device (120) may maintain each of the swappable reagent dispensing cartridges (115) or groups of swappable reagent dispensing cartridges (115) in any physical layout as necessary in order for, for example, an ASRS to access each of the swappable reagent dispensing cartridges (115).

In an example, the storage device (120) may include an off-line rotary carousel system that may include at least one level. The rotary carousel system may be turned such that a mechanical device such as the ASRS system can pick the at least one swappable reagent dispensing cartridge (115) from the storage device (120) and place it in an in-line position. In an example, this off-line rotary carousel system may include multiple levels.

In an example, the storage device (120) is an on-line carousel system. In this example, a portion of the carousel may cause at least one of the swappable reagent dispensing cartridges (115) to be placed in an on-line position while other swappable reagent dispensing cartridges (115) remain on the carousel but in an off-line position. This example provides for a storage device (120) that does not use any additional mechanical devices to swap out swappable reagent dispensing cartridges (115) as described herein. Instead, the on-line carousel system will turn in order to place a selected or appropriate swappable reagent dispensing cartridges (115) or group of swappable reagent dispensing cartridges (115) on-line.

The storage device (120), in an example, may be include multi-dimensional array of locations with at least one swappable reagent dispensing cartridge (115) or at least one group of swappable reagent dispensing cartridges (115) being held at a location within the multi-dimension array of locations. In this example, an ASRS may be implemented to retrieve the appropriate swappable reagent dispensing cartridges (115) from the storage device (120) and swap them out with a swappable reagent dispensing cartridge (115) currently on-line. An addressable mechanical arm may be used in the ASRS to implement the exchange. In an example, the storage device (120) with the multi-dimensional array may comprise compartments that house an individual swappable reagent dispensing cartridges (115) or a group of swappable reagent dispensing cartridges (115).

In any of the examples of storage device (120) described herein, the storage device (120) may house a number of modules that house a plurality of swappable reagent dispensing cartridges (115). The modules may each comprise the wiping and capping devices described herein. Additionally, the modules may be maintained within the storage device (120) similarly to the individual swappable reagent dispensing cartridges (115) herein described. The modules may be used to group a plurality of swappable reagent dispensing cartridges (115) together in order to use that grouping of swappable reagent dispensing cartridges (115) for a specific test to be conducted by the reagent dispensing system (100). A user may select a specific test to conduct using, for example, a user interface of the reagent dispensing system (100) and the reagent dispensing system (100) may determine whether the currently on-line module with its plurality of swappable reagent dispensing cartridges (115) could be used for the test. If not, the reagent dispensing system (100) may swap out one module for a test-appropriate module including those swappable reagent dispensing cartridges (115) that have the appropriate reagents to be used for the selected test.

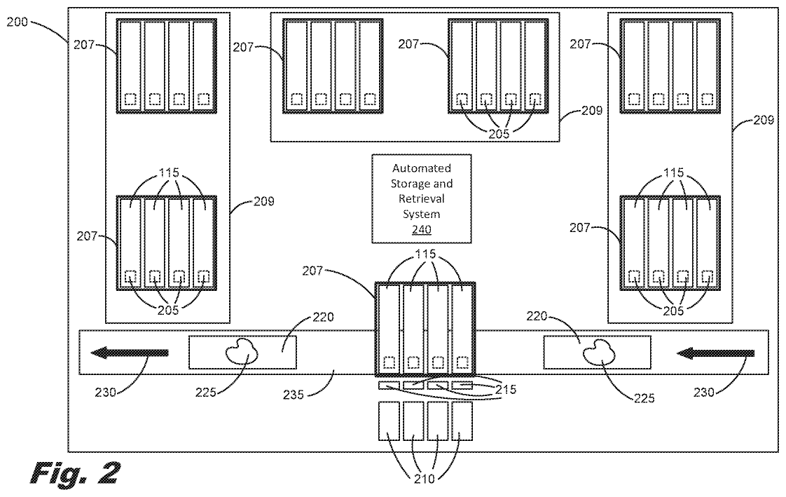

FIG. 2 is a block diagram of a reagent dispensing system (200) according to an example of the principles described herein. In an example, the reagent dispensing system (200) is an automated, computer driven system that dispenses, through a number of reagent dispensing devices, a number of different reagents. The reagents may be any chemical or biological substance that may be used in any chemical reaction such as titrations, combinations, decompositions, single displacements, precipitations, neutralizations, double displacements, combustions, and reductions/oxidations, among other types of chemical or biological reactions. The reagents may be, for example, solutions including nucleic acid; deoxyribonucleic acid (DNA); ribonucleic acid (RNA); small (or short) interfering RNA (siRNA); polymerase chain reaction (PCR) master mix; proteins including, for example, enzymes and antibodies; other biomolecules including, for example, peptides, oligos, and lipids; small molecules, nanoparticles, biocides, cells or other tissue components, histology stains, linker reagents, inhibitors, or other reagents.

In addition to the swappable reagent modules (207) and their respective reagent dispensing cartridges (115) housed therein, the reagent dispensing system (200) may include additional devices that may be used during the testing and/or diagnosis processes. In an example, the reagent dispensing system (200) may include an in-line wiping station (215) for each of the reagent dispensing cartridges (115) as well as an in-line capping station (210). The wiping station (215) may be used to wipe off a number of silicon dies (205) of each of the reagent dispensing cartridges (115). This process may form part of the reagent dispensing cartridges (115) maintenance process used to maintain the health of the silicon dies (205) of the reagent dispensing cartridges (115). The in-line capping station (210) may further cap each of the silicone dies (205) of the reagent dispensing cartridges (115) when the reagent dispensing cartridges (115) are not currently in use by the reagent dispensing system (200) but are maintained at an in-line location. In these examples, the wiping station (215) and in-line capping station (210) may move toward the swappable reagent modules (207) and the individual reagent dispensing cartridges (120) in order to conduct the maintenance processes as described herein.

Alternatively, each of the swappable reagent modules (207) whether in-line or off-line each may include their respective wiping station (215) and capping stations (210). In an example, a module frame of the swappable reagent modules (207) may comprise its own wiping station (215) and capping station (210) mechanically coupled to the module frame. This may allow for each of the swappable reagent modules (207) to be separately maintained without creating cross-contamination of the various reagent fluids of each of the reagent dispensing cartridges (115). Further, the inclusion of the wiping station (215) and capping station (210) with the module frame allows the swappable reagent modules (207) to consistently be maintained regardless of whether they are off-line, in-line, or in transit between the two positions.

The reagent dispensing system (200) may further include a conveyance system (235) that conveys a substrate (220) along the direction of the arrows (230) shown in FIG. 2. In an example, the conveyance system (235) may also move opposite of the arrows (230) so as to allow the substrate (220) to pass, in the opposite direction, under the swappable reagent modules (207) and specifically the reagent dispensing cartridges (115). This may allow for any number of coatings of any of the reagents to be applied to a test sample or substrate (220). Additionally, this may allow for time to pass before a second reagent or an additional layer of reagent is applied thereby allowing, in some examples, a reaction to occur on the substrate (220).

The conveyance system (235) may convey any type of substrate (220) onto which a reagent ejected from the reagent dispensing cartridges (115) may be placed. In an example and in the example shown in FIG. 2, the substrate (220) is a microscope slide or other slide that may carry a test sample (225). Other substrates (220) may be used either alone or in combination with a test sample (225) and the present specification contemplates the use of those other substrates (220). Example substrates include silicon wafers, silicon chips, lateral flow substrates, microfluidic devices, or microtiter plates.

The reagent dispensing system (200) may further include an automated storage and retrieval system (ASRS) (240) may be used to transport the swappable reagent modules (207) to and from the area along the conveyance system (235). The ASRS (240) may include any number of conveyor systems, lift systems, robotic arms, other ASRS systems, and combinations thereof. In another example, a technician may manually exchange the swappable reagent modules (207) by removing them from an off-line location in a module storage device (120) and placing the swappable reagent modules (207) in an in-line position.

FIG. 2 shows the plurality of swappable reagent modules (207) with each of the swappable reagent modules (207) including, in this example, four reagent dispensing cartridges (115). It is to be understood that the number of swappable reagent modules (207) and their respective reagent dispensing cartridges (115) are merely examples and the depicted number of these swappable reagent modules (207) and their respective reagent dispensing cartridges (115) are not meant to be limiting. The swappable reagent modules (207), however, provide for a plurality of sample tests and/or diagnosis to be conducted using the reagent dispensing system (200). By way of an example only, a user may wish to conduct a plurality of different tests implementing any number and/or combination of reagents housed within each of the reagent dispensing cartridges (115). In an example, the reagents housed within each of the reagent dispensing cartridges (115) of a given swappable reagent module (207) may be selected based on a test to be conducted by the reagent dispensing system (200). Thus, a user may be able to select, via a graphical user interface associated with the reagent dispensing system (200) for example, a specific type of test to be conducted on a test sample and the reagent dispensing system (200) may implement that swappable reagent module (207) having those reagent dispensing cartridges (115) that hold the appropriate type and/or amount of reagent fluid for the test. In some examples, specific swappable reagent modules (207) used for a specific test may be swapped out with an in-line swappable reagent module (207) in order to conduct that test using the appropriate reagents. In some examples, a plurality of reagent dispensing cartridges (115) maintained in a plurality of swappable reagent modules (207) may hold the same type of reagent but may be grouped with other reagents in order to conduct different types of tests.

The reagent dispensing system (200) may further include a number of trays (209) that house a plurality of swappable reagent modules (207). The trays (209) may each be removable by a user from the reagent dispensing system (200). In an example, a user may prepare the reagent dispensing system (200) for a plurality of test to be conducted by the reagent dispensing system (200) by selecting specific reagents to be used in connection with specific tests. As an example, a user may prepare the reagent dispensing system (200) to conduct a specific test by selecting, in the example shown in FIG. 2, up to 4 different reagent dispensing cartridges (115) comprising up to four different reagents. The reagent dispensing cartridges (115) may then be placed within a swappable reagent module (207). The swappable reagent module (207) may then be placed within one of the trays (209) and the trays (209) may be placed within the storage device (120) of the reagent dispensing system (200). During operation of the reagent dispensing system (200), the reagent dispensing system (200) may detect an identification placed on the reagent dispensing cartridges (115) and/or swappable reagent modules (207), determine which reagents are held within the reagent dispensing cartridges (115), and assign or otherwise associate those reagents and, consequently, those reagent dispensing cartridges (115) and swappable reagent modules (207) to specific tests that are to be conducted by the reagent dispensing system (200). In an example, the user, via a user interface on the reagent dispensing system (200), may assign specific swappable reagent modules (207) and their respective reagent dispensing cartridges (115) to a specifically selected test. Additionally, the user may be provided with a graphical user interface that describes the reagents housed within each of the reagent dispensing cartridges (115) as well as how each of the reagent dispensing cartridges (115) may be grouped into any number of swappable reagent modules (207).

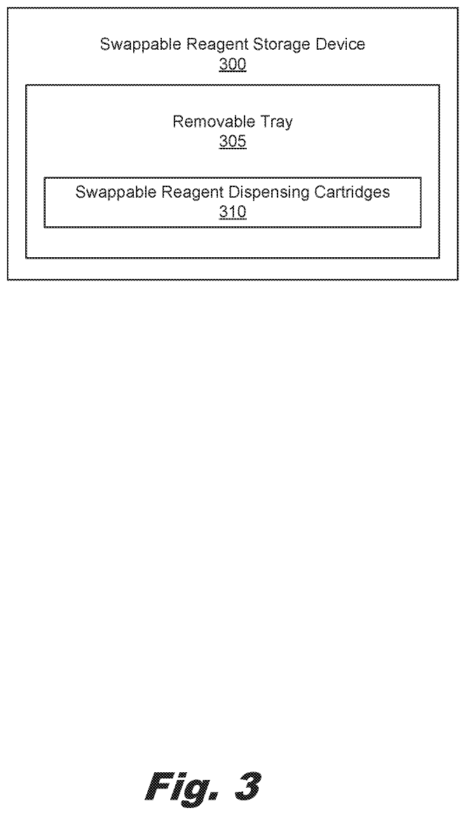

FIG. 3 is a block diagram of a swappable reagent storage device (300) according to an example of the principles described herein. The swappable reagent storage device (300) may include at least one removable tray (305) with a number of swappable reagent dispensing cartridges (310) maintained therein. The removable tray (305) may be similar to the tray described above in connection with FIG. 2. the removable tray (305) may include specific hardware used to selectively house a number of swappable reagent modules (207) so that they will not be dislodged while being stored within the swappable reagent storage device (300). As described above, each of the swappable reagent dispensing cartridges (310) may include an identification indicating what reagent is maintained therein. The specific swappable reagent dispensing cartridges (310) may be housed within the swappable reagent storage device (300) at a predetermined location. In an example, whenever a swappable reagent dispensing cartridges (310) is removed from its location within the swappable reagent storage device (300), it may be subsequently returned to that location it was removed from. This may provide for a reserved location within the swappable reagent storage device (300) for a swappable reagent dispensing cartridges (310) housing a specific reagent. In another example, any given swappable reagent dispensing cartridges (310) may be returned to any location within any removable tray (305) of the swappable reagent storage device (300). In any example, the locations of each of the swappable reagent dispensing cartridges (310) may be determined and maintained in a data storage device associated with the swappable reagent storage device (300).

As mentioned previously, a number of swappable reagent dispensing cartridges (310) may also be housed within a swappable reagent module (207). The swappable reagent modules (207) may then be maintained in the removable tray (305) similar to the individual swappable reagent dispensing cartridges (310) described. Thus, a user may be able to select, for a specific test, a single swappable reagent dispensing cartridges (310) or a grouped plurality of swappable reagent dispensing cartridges (310) in order to conduct a test.

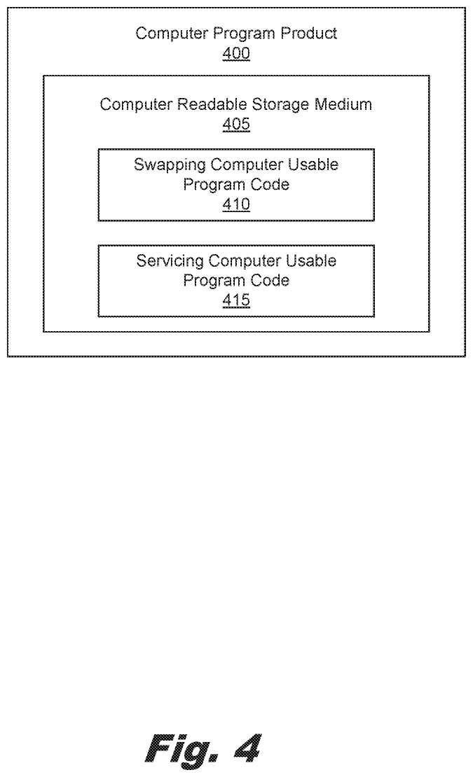

FIG. 4 is a block diagram of a computer program product (400) according to an example of the principles described herein. The computer program product (400) may include computer readable storage medium (405) that embodies certain computer usable program code. Among the computer usable program code is computer usable program code (410, 415) to, when executed by a processor, swap at least one swappable reagent dispensing cartridge between an in-line position within a reagent dispensing system to an off-line storage device and service a number of swappable reagent dispensing cartridges within the storage device. The computer program product (400) may further include computer usable program code to cause certain devices to alter or maintain an environment within a swappable reagent storage device (300) as described herein.

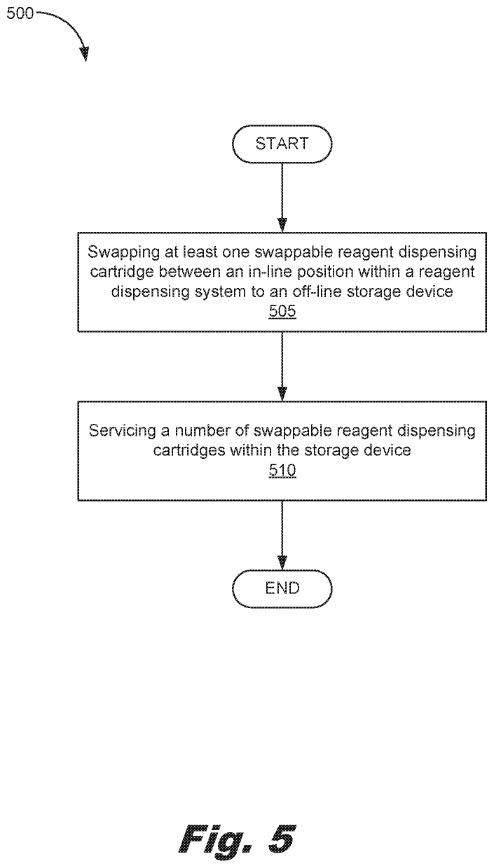

FIG. 5 is a block diagram of a method (500) for operating a reagent dispensing system (100, 200) according to an example of the principles described herein. The method (500) may begin by swapping (505) at least one swappable reagent dispensing cartridge between an in-line position within a reagent dispensing system to an off-line storage device. The method (500) further includes servicing (510) a number of swappable reagent dispensing cartridges within the storage device.

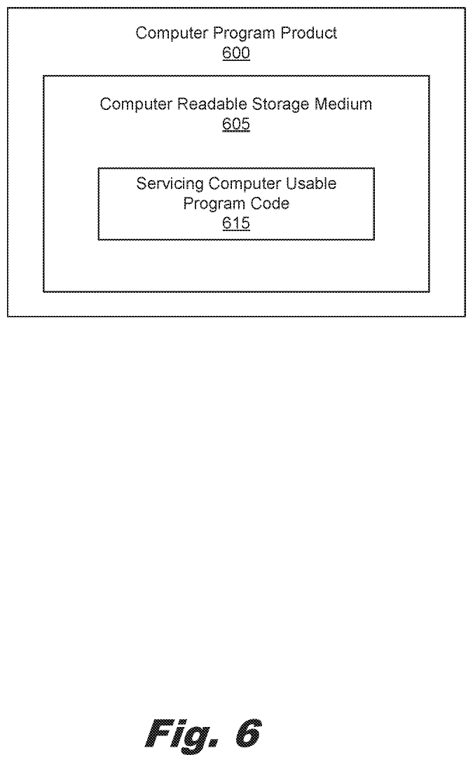

FIG. 6 is a block diagram of a computer program product (600) according to an example of the principles described herein. The computer program product (600) may include computer readable storage medium (605) that embodies certain computer usable program code. Among the computer usable program code is computer usable program code (615) to, when executed by a processor, service a number of swappable reagent dispensing cartridges within a storage device wherein each of the number of swappable reagent dispensing cartridges are serviced based on a type of reagent maintained therein. The computer program product (600) may further include computer usable program code to exchange a first of the number of swappable reagent dispensing cartridges from an on-line position to an off-line position within the storage device.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, a processor associated with the reagent dispensing system (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describes a reagent fluid cartridge storage device and methods of using that storage device. The storage device may interface with a reagent dispensing system such that a number of reagent dispensing cartridges may be swapped from an on-line position to an off-line position and visa-versa. An ASRS may be used to complete the swapping. The storage device may be environmentally controlled so as to maintained the reagents within the swappable reagent dispensing cartridges for future use and when not in use. Additionally, any number of reagent fluids may be used for any type of testing or diagnosis process without the user having to physically swap out swappable reagent dispensing cartridges. The storage device further includes servicing devices that help to maintain the health of the swappable reagent dispensing cartridges and specifically an ejection device found thereon. A processor may direct the servicing of the swappable reagent dispensing cartridges such that periodic servicing is accomplished.

The preceding description has been presented to illustrate and describe examples of the principles described. This description is not intended to be exhaustive or to limit these principles to any precise form disclosed. Many modifications and variations are possible in light of the above teaching.

What is claimed is:

1. A reagent dispensing system, comprising:
a processing device;
a data storage device coupled to the processing device; and
a plurality of swappable reagent dispensing cartridges;
wherein a first set of the swappable reagent dispensing cartridges are maintained within a storage device off-line from a second set of swappable reagent dispensing cartridges maintained in-line.

2. The reagent dispensing system of claim 1, wherein each of the swappable reagent dispensing cartridges of the first and second set of swappable reagent dispensing cartridges include an identity tag.

3. The reagent dispensing system of claim 1, wherein the first set of swappable reagent dispensing cartridges are not in use by the reagent dispensing system to dispense a reagent therefrom.

4. The reagent dispensing system of claim 3, wherein the first set of swappable reagent dispensing cartridges interface with a capping system within the storage device.

5. The reagent dispensing system of claim 1, wherein the storage device comprises environmental controls.

6. The reagent dispensing system of claim 5, wherein the environmental controls control the temperature of the reagents, humidity exposure of the reagent dispensing cartridges, electromagnetic wave exposure to the reagent dispensing cartridges, or combinations thereof.

7. The reagent dispensing system of claim 1, wherein the storage device is a rotary carousel that maintains the first set of swappable reagent dispensing cartridges off-line while simultaneously maintaining the second set of swappable reagent dispensing cartridges in-line.

8. The reagent dispensing system of claim 1, wherein the storage device is a compartment within the reagent dispensing system that locates each of the swappable reagent dispensing cartridges of the first set of swappable reagent dispensing cartridges on a multi-dimensional array.

9. The reagent dispensing system of claim 1, wherein the storage device comprises an automatic storage and retrieval system to retrieve the first set of the swappable reagent dispensing cartridges from the storage device and exchange it in-line for the second set of swappable reagent dispensing cartridges.

10. A swappable reagent cartridge storage device, comprising:
a plurality of swappable reagent dispensing cartridges maintained in the storage device, each of the swappable reagent dispensing cartridges being grouped within a removable tray; and
a swapping device to exchange at least one of the swappable reagent dispensing cartridges within the storage device.

11. The swappable reagent cartridge storage device of claim 10, further comprising at least one capping device to cap at least one swappable reagent dispensing cartridge while the at least one swappable reagent dispensing cartridge is maintained in the storage device.

12. The swappable reagent cartridge storage device of claim 10, further comprising environmental controls.

13. The swappable reagent cartridge storage device of claim 12, wherein the environmental controls control the temperature of the reagents, humidity exposure of the reagent dispensing cartridges, electromagnetic wave exposure to the reagent dispensing cartridges, or combinations thereof.

14. A computer program product for dispensing a reagent, comprising:
a computer readable storage medium comprising computer usable program code embodied therewith, the computer usable program code to, when executed by a processor:
service a number of swappable reagent dispensing cartridges within a storage device;
wherein each of the number of swappable reagent dispensing cartridges are serviced based on a type of reagent maintained therein.

15. The computer program product of claim 14, further comprising computer usable program code to, when executed by a processor, exchange a first of the number of swappable reagent dispensing cartridges from an on-line position to an off-line position within the storage device.
